(19) United States
(12) Patent Application Publication
(10) Pub. No.: US 2008/0146063 A1
(43) Pub. Date: Jun. 19, 2008

(54) FLAT DISPLAYS AND FLEXIBLE CONDUCTORS THEREOF

(75) Inventor: Shih-An Lin, Taipei County (TW)

Correspondence Address: QUINTERO LAW OFFICE, PC, 2210 MAIN STREET, SUITE 200, SANTA MONICA, CA, 90405, US

(73) Assignees: QISDA CORPORATION, TAOYUAN COUNTY (TW); BENQ CORPORATION, Taipei (TW)

(21) Appl. No.: 11/957,026

(22) Filed: Dec. 14, 2007

(30) Foreign Application Priority Data
Dec. 15, 2006 (TW) TW95147071

(51) Int. Cl. H01R 13/62

(52) U.S. Cl. 439/329

(57) ABSTRACT

Flexible conductors are provided for electrically connecting a connector and a frame of a flat display. A flexible conductor includes a hollow quadrilateral main body encompassing the connector and a plurality of tabs contacting the frame. The main body has a quadrilateral opening and a slot. The quadrilateral opening is substantially perpendicular to a central axis of the main body. The slot substantially extends through the main body along the central axis. The tabs are adjacent to the opening and project from an edge of the main body.

### BACKGROUND OF THE INVENTION

1. Field of the Invention

The invention relates in general to flat displays and in particular to flat displays having flexible conductors.

2. Description of the Related Art

Conventional flat displays include a circuit board with various connectors disposed thereon for signal transmission, such as AC, earphone, D-sub, DVI, or HDMI connectors. To prevent EMI, the connectors are usually grounded by gaskets or aluminum foil. However, gaskets or aluminum foils can complicate assembly and robust attachment to the connectors.

### BRIEF SUMMARY OF THE INVENTION

Flexible conductors are provided for electrically connecting a connector and a frame of a flat display. A flexible conductor includes a hollow quadrilateral main body encompassing the connector and a plurality of tabs contacting the frame. The main body has a quadrilateral opening and a slot. The quadrilateral opening is substantially perpendicular to a central axis of the main body. The slot substantially extends through the main body along the central axis. The tabs are adjacent to the opening and project from an edge of the main body.

### BRIEF DESCRIPTION OF THE DRAWINGS

The invention can be more fully understood by reading the subsequent detailed description and examples with references made to the accompanying drawings, wherein:

FIG. 1 is an exploded diagram of a flat display;

FIGS. 2A-2C are perspective diagrams of a flexible conductor;

FIG. 3 is a perspective diagram of a flexible conductor encompassing a connector;

FIG. 4 is a perspective diagram of a flexible conductor connecting a connector and a frame of a flat display; and

FIG. 5 is a large view of portion A in FIG. 4.

### DETAILED DESCRIPTION OF THE INVENTION

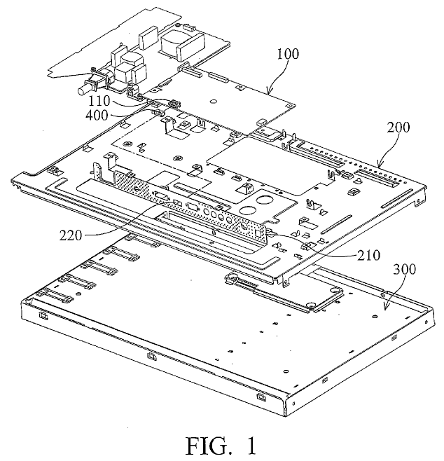

Referring to FIG. 1, an embodiment of a flat display, such as an LCD, primarily includes a circuit board 100, a frame 200, a display unit 300, and a hollow flexible conductor 400. As shown in FIG. 1, the frame 200 is mounted on a rear surface of the display unit 300, and the circuit board 100 is fixed to the frame 200. The circuit board 100 comprises a connector 110 disposed at an edge thereof, and the flexible conductor 400 encompasses the connector 110 and electrically connects the frame 200.

In this embodiment, the frame 200 has a flange 210 substantially perpendicular to the circuit board 100, wherein the flange 210 has a hole 220 corresponding to the connector 110. During assembly, the flexible conductor 400 is disposed through the hole 220 of the flange 210 and electrically connects the connector 110 and the frame 200. Hence, the connector 110 is grounded to the frame 200 via the flexible conductor 400 to prevent EMI.

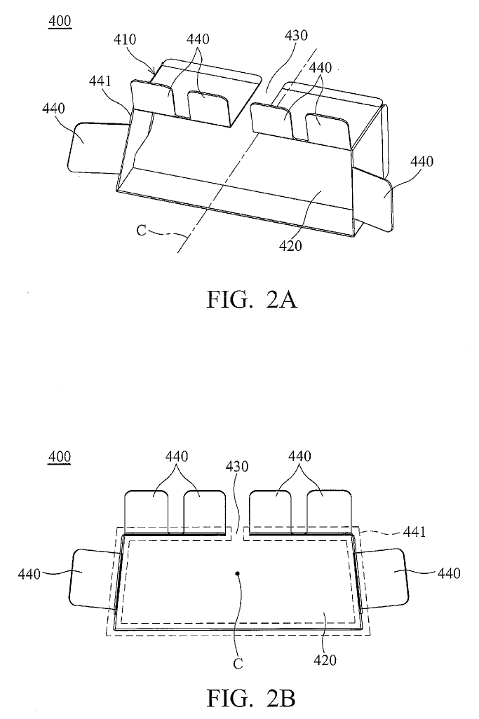

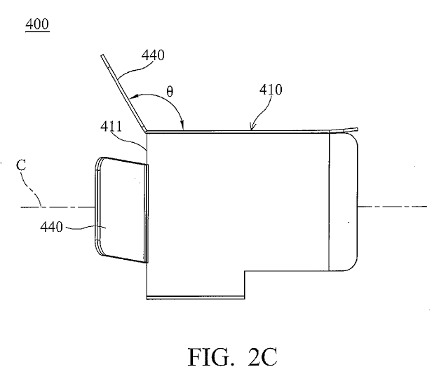

Referring to FIGS. 2A-2C, the flexible conductor 400 primarily comprises a main body 410 and a plurality of tabs 440 projecting therefrom. As shown in FIGS. 2A and 2B, the flexible conductor 400 forms a quadrilateral opening 420 and a longitudinal slot 430 communicating with the opening 420. The opening 420 is substantially trapezoid and perpendicular to a central axis C of the main body 410. The slot 430 is disposed through a top side of the main body 410 along the central axis C.

As shown in FIG. 2B, the tabs 440 are adjacent to the opening 420 and extend from an edge 411 of the main body 410, wherein the opening 420 is defined by the edge 411. Referring to FIG. 2C, the tabs 440 project from the edge 411 along the central axis C and form an obtuse angle θ with respect to the main body 410.

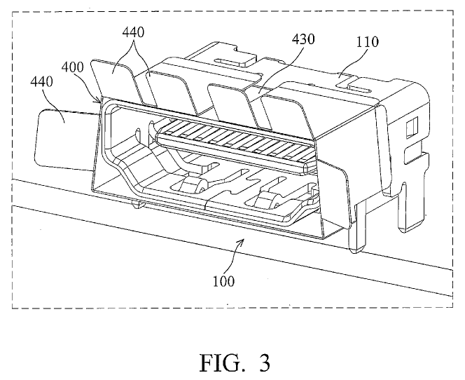

During assembly, the flexible conductor 400 contacts and encompasses the connector 110, as shown in FIG. 3, wherein the connector 110 is situated between the circuit board 100 and the slot 430. In this embodiment, the flexible conductor 400 is integrally formed in one piece, such as a metal sheet. The slot 430 facilitates flexibility of the flexible conductor 400 and improves attachment to the connector 110.

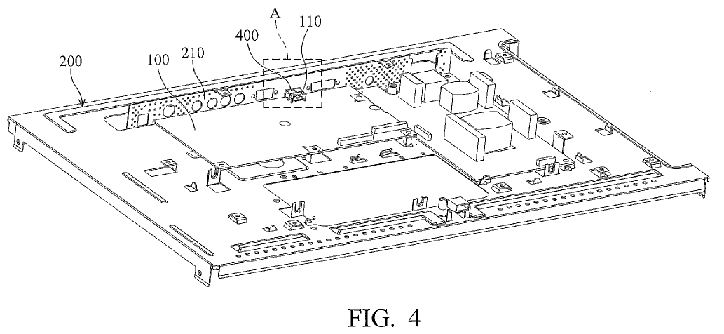

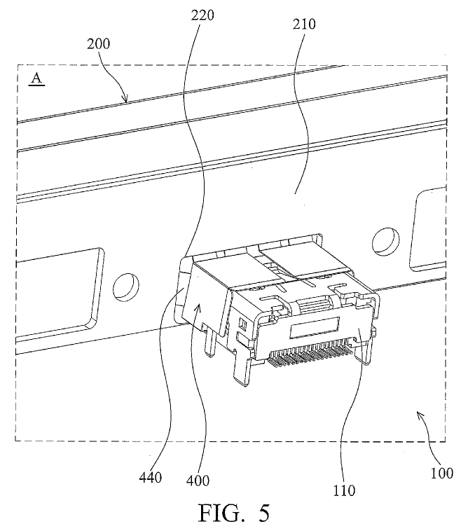

Referring to FIGS. 4 and 5, during assembly, the tabs 440 of the flexible conductor 400 extend through the hole 220 and electrically connect the connector 110 and the flange 210 of the frame 200. Thus, the connector 110 is grounded to the frame 200 to prevent EMI.

In this embodiment, the connector 110 is an HDMI connector. However, the flexible conductor 400 can also be applied to various connectors for EMI grounding, facilitating easy assembly and robust connection with low cost.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A flat display, comprising:
a display unit;
a frame, connected to the display unit;
a circuit board, disposed on the frame;
a connector, disposed on the circuited board; and
a flexible conductor, including a hollow main body encompassing the connector, the main body comprising a quadrilateral opening and a slot, wherein the quadrilateral opening is substantially perpendicular to a central axis of the main body, and the slot extends through the main body substantially along the axis; and
a plurality of tabs, adjacent to the opening, projecting from an edge of the main body and contacting the frame.

2. The flat display as claimed in claim 1, wherein the frame comprises a hole with the flexible conductor disposed therethrough and connected to the frame.

3. The flat display as claimed in claim 2, the frame further comprising a flange perpendicular to the circuit board, wherein the opening is formed on the flange.

4. The flat display as claimed in claim 1, wherein the opening is substantially trapezoid.

5. The flat display as claimed in claim 1, wherein the tabs project from an edge of the main body along the central axis.

6. The flat display as claimed in claim 1, wherein each of the tabs and the main body form an obtuse angle.

7. The flat display as claimed in claim 1, wherein the connector is an HDMI connector.

8. The flat display as claimed in claim 1, wherein the flexible conductor is integrally formed in one piece.

9. The flat display as claimed in claim 1, wherein the flexible conductor comprises metal.

10. The flat display as claimed in claim 1, wherein the connector is disposed between the slot and the circuit board.

11. A flexible conductor electrically connecting a connector and a frame of a flat display, comprising:
a hollow main body, being substantially quadrilateral and encompassing the connector, comprising a quadrilateral opening and a slot, wherein the quadrilateral opening is substantially perpendicular to a central axis of the main body, and the slot extends through the main body substantially along the axis; and
a plurality of tabs, adjacent to the opening, projecting from an edge of the main body and contacting the frame.

12. The flexible conductor as claimed in claim 11, wherein the frame comprises a hole with the flexible conductor disposed therethrough and connected to the frame.

13. The flexible conductor as claimed in claim 12, the frame further comprising a flange perpendicular to the circuit board, wherein the opening is formed on the flange.

14. The flexible conductor as claimed in claim 11, wherein the opening is substantially trapezoid.

15. The flexible conductor as claimed in claim 11, wherein the tabs project from an edge of the main body along the central axis.

16. The flexible conductor as claimed in claim 11, wherein each of the tabs and the main body form an obtuse angle.

17. The flexible conductor as claimed in claim 11, wherein the connector is an HDMI connector.

18. The flexible conductor as claimed in claim 11, wherein the flexible conductor is integrally formed in one piece.

19. The flexible conductor as claimed in claim 11, wherein the flexible conductor comprises metal.

20. The flexible conductor as claimed in claim 11, wherein the connector is disposed between the slot and the circuit board.
